(19) United States
(12) Patent Application Publication
(10) Pub. No.: US 2014/0183015 A1
(43) Pub. Date: Jul. 3, 2014

(54) PUSH SWITCH

(71) Applicant: HOSIDEN CORPORATION, Yao-shi (JP)

(72) Inventor: Takuhiko SAOMOTO, Yao-shi (JP)

(73) Assignee: HOSIDEN CORPORATION, Yao-shi (JP)

(21) Appl. No.: 14/140,864

(22) Filed: Dec. 26, 2013

(30) Foreign Application Priority Data
Dec. 28, 2012 (JP) 2012-287223

(51) Int. Cl. H01H 13/10

(52) U.S. Cl. CPC H01H 13/10
USPC 200/247

(57) ABSTRACT

The invention provides a push switch including a keytop movable in a first direction, a switch, first and second circuit boards, an electronic component mounted on the second circuit board, first and second circuits electrically connected to the switch, and a body. The switch is turned on or off in response to movement of the keytop. The first circuit on the first circuit board is configured to protect the switch. The second circuit on the second circuit board is configured to actuate the electronic component in response to a turn-on or turn-off of the switch. The body includes a main body and first and second holders. The first holder at the main body holds the first circuit board. The second holder at the main body or the first holder holds the second circuit board in spaced relation to the first circuit board in the first direction.

### CROSS-REFERENCE TO RELATED APPLICATIONS

The present application claims priority under 35 U.S.C. §119 of Japanese Patent Application No. 2012-287223 filed on Dec. 28, 2012, the disclosure of which is expressly incorporated by reference herein in its entity.

### BACKGROUND OF THE INVENTION

1. Technical Field

The present invention relates to push switches.

2. Background Art

Japanese Unexamined Utility Model Application Publication No. 06-62438 discloses a push switch including a circuit board, a keytop, a depression switch, and an LED. The keytop is disposed so as to be movable toward the circuit board. The depression switch is mounted on the circuit board and is turned on in response to the movement of the keytop. The LED is mounted on the circuit board and turned on by the turn-on of the depression switch.

### SUMMARY OF INVENTION

In the above push switch, the depression switch and the LED are mounted on the circuit board, so that a protection circuit for protecting the depression switch and an illumination circuit for turning on the LED are also provided on the circuit board. This arrange requires a large circuit board, and it is therefore difficult to reduce the external size of the push switch.

Further, the depression switch, the protection circuit, the LED, and the illumination circuit are arranged on the same circuit board. Therefore, the above push switch cannot be modified to a structure that requires neither LEDs nor illumination circuits.

The invention has been devised in view of the above situation and provides a push switch that can be downsized and has high versatility.

An aspect of the invention provides a push switch including a keytop, a switch, first and second circuit boards, an electronic component, first and second circuits, and a body. The keytop is movable in a first direction. The switch is configured to be turned on or off in response to movement of the keytop. The first and second circuit boards are electrically connected to the switch. The electronic component is mounted on the second circuit board. The first circuit is provided on the first circuit board and configured to protect the switch. The second circuit is provided on the second circuit board and configured to actuate the electronic component in response to a turn-on or turn-off of the switch. The body includes a main body and first and second holders. The first holder is provided at the main body and configured to hold the first circuit board. The second holder is provided at the main body or the first holder and is configured to hold the second circuit board in spaced relation to the first circuit board in the first direction.

The push switch of such an aspect has a reduced projected area from the first direction, resulting in downsizing of the push switch. This is because the first circuit for protecting the switch is provided in the first circuit board, the electronic component and the second circuit for actuating the electronic component are provided in the second circuit board, and the first and second circuit boards are held in spaced relation to each other along the first direction by the first and second holders of the body. Further advantageously, the above push switch has a high versatility. Particularly, by removing the second circuit board provided with the electronic component and the second circuit, the push switch can be modified to a push switch that does not require any electronic components. Alternatively, by replacing the second circuit board with another second circuit board that is provided with a different electronic component and a different second circuit for actuating the electronic component, the push switch can also be applied to a push switch for actuating a different electronic component.

The switch may include first and second fixed contacts and a movable contact. The first and second fixed contacts may each be a metal plate passing through the first and second circuit boards. The movable contact at an initial position may not be in contact with at least one of the first fixed and second fixed contacts, and the movable contact may be movable from the initial position in response to the movement of the keytop to be in contact with the first and second fixed contacts. Alternatively, the movable contact at an initial position may be in contact with the first fixed and second fixed contacts, and the movable contact may be movable from the initial position in response to the movement of the keytop so as to be brought out of contact with at least one of the first and second fixed contacts.

According to the push switch of these aspects, by making the first and second fixed contacts pass through the first and second circuit board, the first and second circuit boards are held by and also electrically connected to the first and second fixed contacts. This arrangement facilitates the fixing of the first and second circuit boards and the electrical connection between the first and second fixed contacts and the first and second circuit boards.

The body may partially hold the first and second fixed contacts. The first and second fixed contacts may each include a connection portion. The connecting portion may be disposed outside the body and pass through the first and second circuit boards.

According to the push switch of such an aspect, the connection portions of the first and second fixed contacts are arranged outside the body, and penetrate the first and second circuit boards. Therefore, the first and second circuit boards can be held by the first and second holders of the body, and the connection portions of the first and second fixed contacts can penetrate the first and second circuit boards to achieve electrical connection therebetween.

The second holder may include a plurality of pillars on the first holder. The pillars may extend in the first direction. The second circuit board may be held on the pillars. The first circuit board may be placed on the first holder so as to abut the pillars and be fixed in position by the pillars.

In the push switch of this aspect, when the first circuit board is placed on the first holder and brought into abutment with the pillars, the first circuit board is fixed in position by the pillars. Therefore, it is easy to fix the first circuit board in position.

The first circuit board may include a guide recess configured to fittingly receive the pillars in a movable manner in the first direction.

The push switch of this aspect makes it possible to move the first circuit board in the first direction by fitting the pillars in the guide recess of the first circuit board. The pillars guide the first circuit board so as to be placed on the first holder. Therefore, this aspect of the invention makes it easy to place and fix the first circuit board in position on the first holder.

### BRIEF DESCRIPTION OF DRAWINGS

FIG. 1A is a front, top, right side perspective view of a push switch according to an embodiment of the invention;

FIG. 1B is a front, bottom, and left side perspective view of the push switch;

FIG. 2A is a cross-sectional view of the push switch with a keytop in an initial state, taken along line 2A-2A in FIG. 1A;

FIG. 2B is a cross-sectional view of the push switch with the keytop in a depressed state, i.e. the state where the keytop is depressed, taken along line 2A-2A in FIG. 1A;

FIG. 2C is a cross-sectional view of the push switch with the keytop in the initial state, taken along line 2C-2C in FIG. 1A;

FIG. 2D is a cross-sectional view of the push switch with the keytop in the depressed state, taken along line 2C-2C in FIG. 1A;

FIG. 3A is an exploded perspective view of the push switch, as viewed from the front, top, and right side thereof;

FIG. 3B is an exploded perspective view of the push switch, as viewed from the back, bottom, and left side thereof;

FIG. 4 is a perspective view of a body, fixed contacts of switches, terminals, first and second circuit boards, and electrical components of the push switch, as viewed from the front, top and right side thereof;

FIG. 5A is a perspective view of the fixed contacts and the terminals of the push switch, as viewed from the front, top, and right side thereof; and

FIG. 5B is a back, top, and left side perspective view of the fixed contacts and the terminals of the push switch.

### DESCRIPTION OF EMBODIMENTS

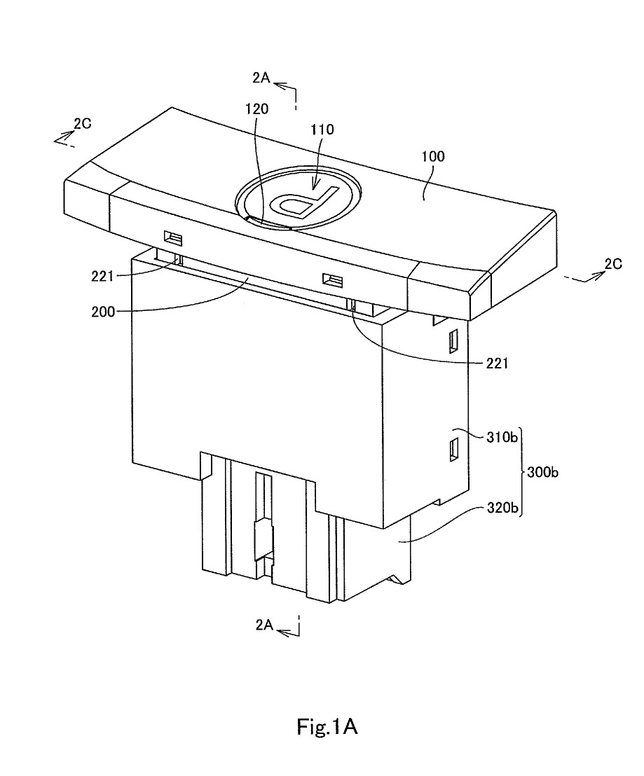

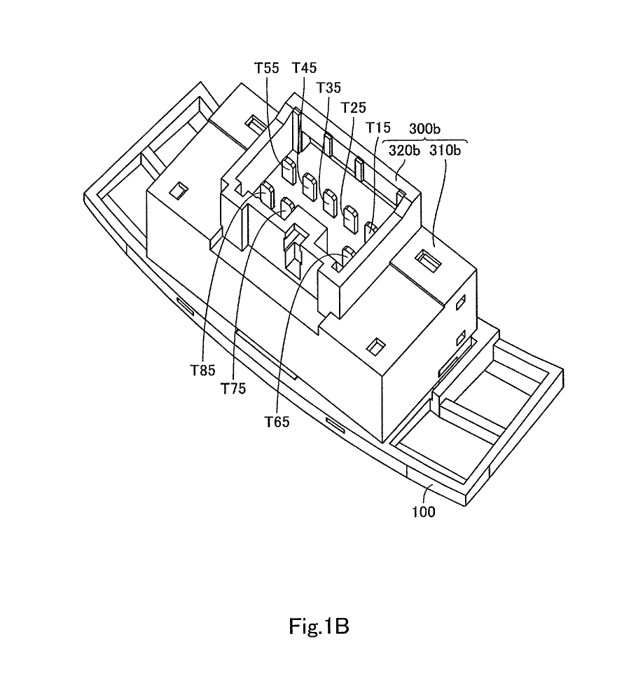

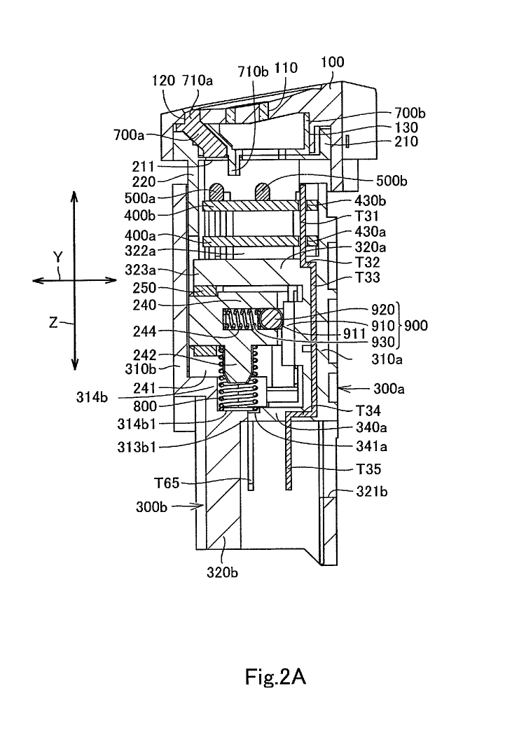

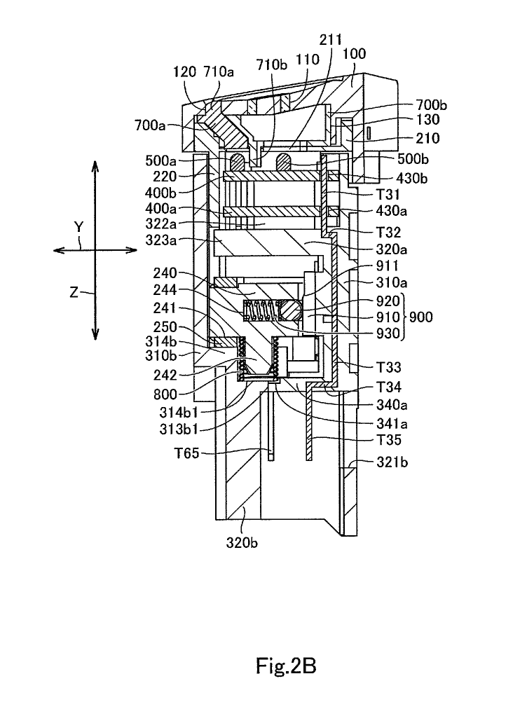

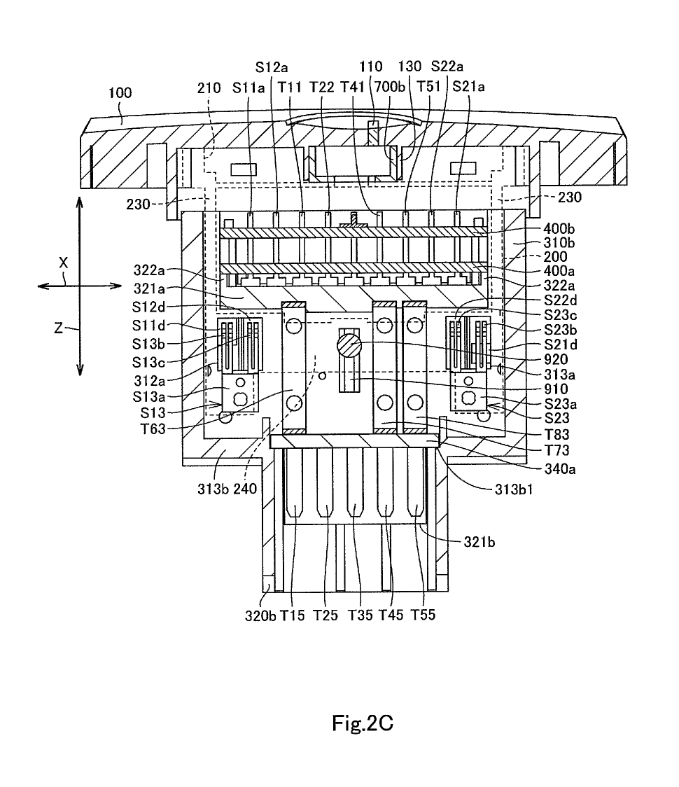

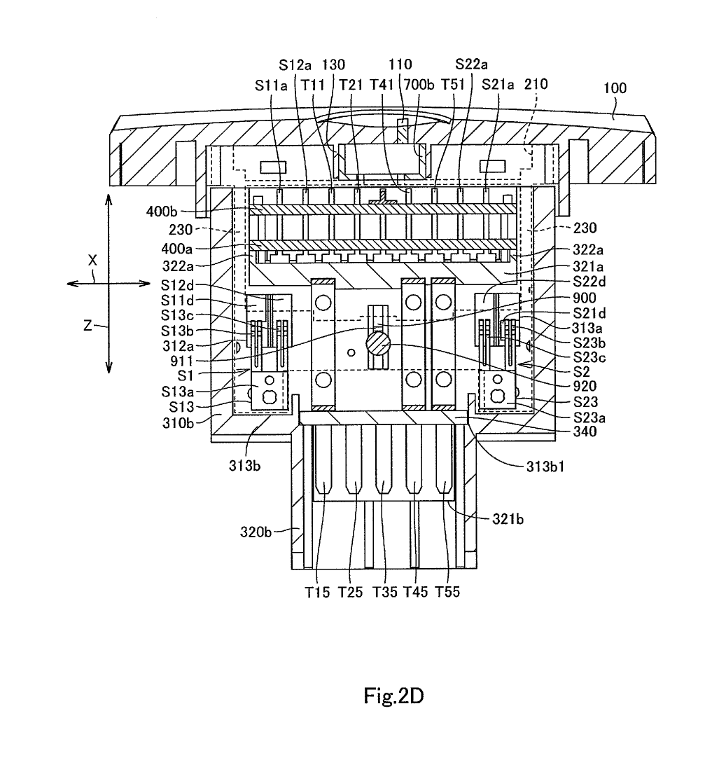

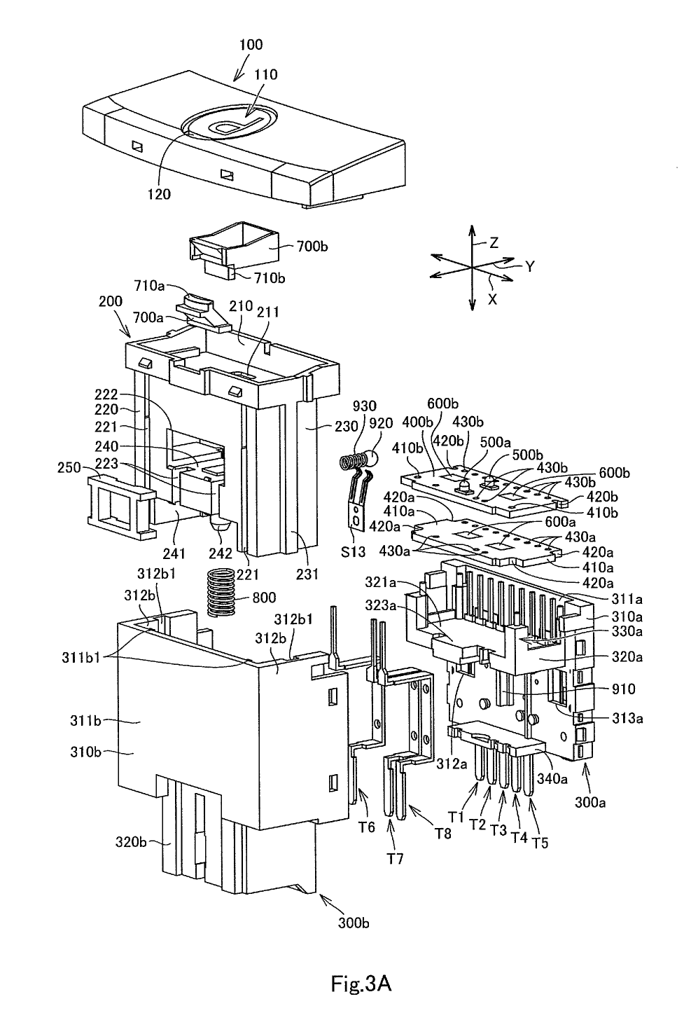

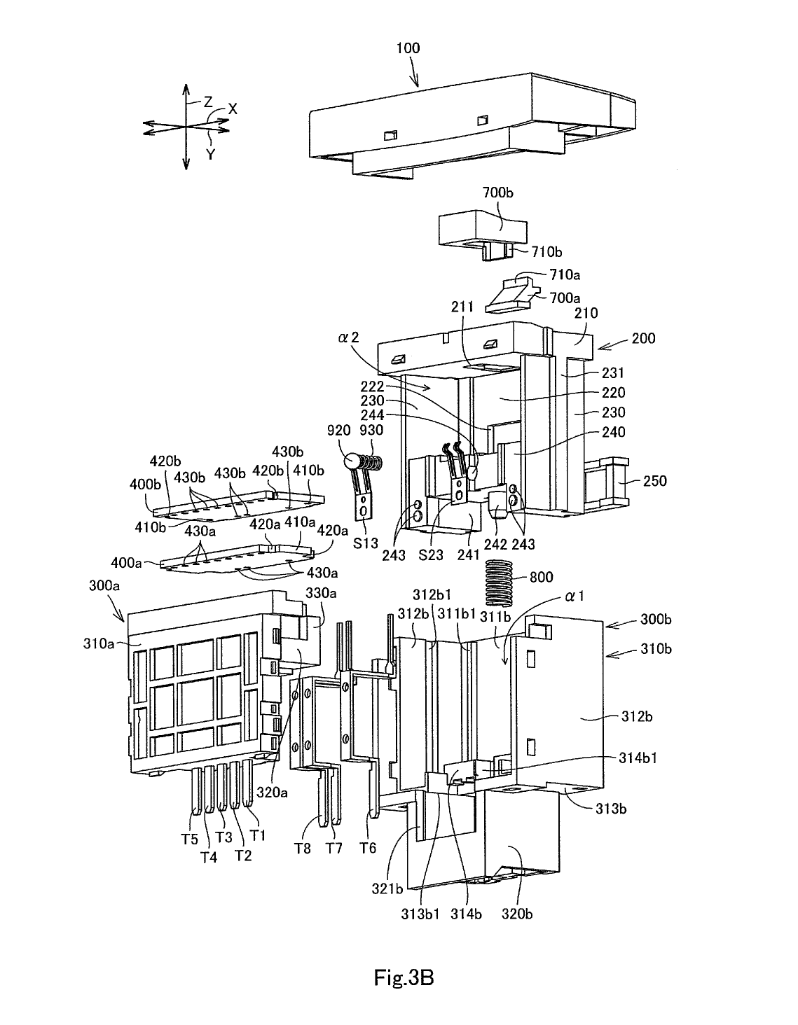

A push switch according to an embodiment of the invention will be described below with reference to FIGS. 1A to 5B. The push switch illustrated in FIGS. 1A and 1B is a parking switch in which a P mark 110 grows by depressing a keytop 100 in a first direction Z. The push switch includes the keytop 100, a slider 200, a body 300a, a case 300b, switches S1 and S2, terminals T1, T2, T3, T4, T5, T6, T7 and T8, first and second circuit boards 400a and 400b, electronic components 500a and 500b, a pair of first circuits 600a, a pair of second circuits 600b, a lens 700a, a light shield block 700b, a coil spring 800, and a tactile feel generator 900. These components of the push switch will be described below in detail. The first direction Z indicated in FIGS. 2A to 3B is the height direction of the push switch as well as a movement direction of the keytop 100. A second direction X indicated in FIGS. 2C to 3B is the width direction of the push switch. A third direction Y indicated in FIGS. 2A, 2B, 3A and 3B is the depth direction of the push switch. The second direction X is perpendicular to the first direction Z. The third direction Y is perpendicular to the first direction Z and the second direction X. For convenience of explanation, the slider 200 is illustrated in broken lines in FIGS. 2C and 2D.

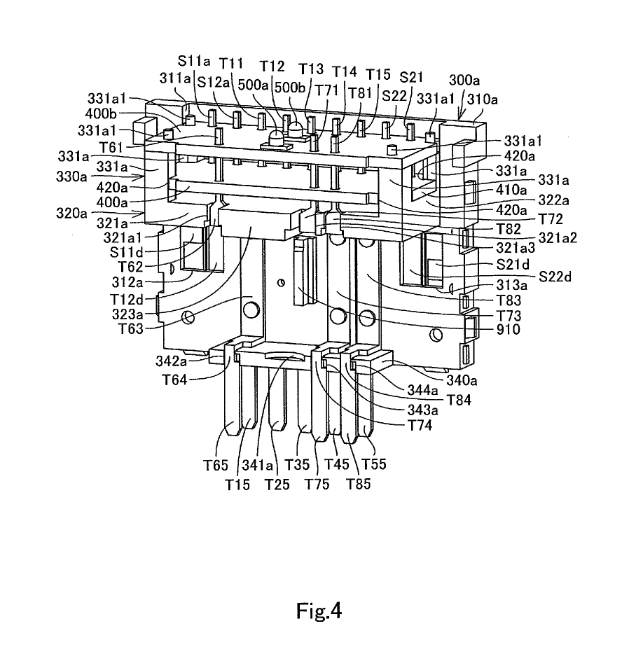

The body 300a is made of insulating plastic material. As illustrated in FIGS. 3A to 4, the body 300a includes a main body 310a, a first holder 320a, a second holder 330a, and a third holder 340a.

The main body 310a is a generally rectangular plate. A generally rectangular recess 311a is provided on the upper end (the end on a first side in the first direction Z) of the inner face of the main body 310a. The recess 311a opens upward (toward the first side in the first direction Z). Generally rectangular recesses 312a and 313a are provided below the recess 311a (on a second side in the first direction Z), on opposite ends in the second direction X of the inner face of the main body 310a.

As illustrated in FIGS. 2A to 2D and FIG. 4, the first holder 320a includes a plate 321a, a pair of pedestals 322a, and a stop 323a. The plate 321a is a generally rectangular plate extends in the third direction Y, integrally formed with a portion between the recess 311a and the recesses 312a and 313a of the inner face of the main body 310a. The pedestals 322a are rectangular prisms extend in the third direction Y on opposite ends in the second direction X of the plate 321a. The stop 323a is a generally rectangular projection in the center of a distal end face (an end face on the first side in the third direction Y) of the plate 321a. An attaching recess 321a1 is provided in the distal end face of the plate 321a, on a first side in the second direction X with respect to the stop 323a. Attaching recesses 321a2 and 321a3 are also provided in spaced relation to each other in the second direction X, on a second side in the second direction X with respect to the stop 323a in the distal end face of the plate 321a.

The second holding 330a has four pillars 331a. The pillars 331a are square poles that stand on respective four corners of the plate 321a and extend toward the first side in the first direction Z. Two of the pillars 331a are located on opposite sides in the third direction Y of one of the pair of pedestals 322a on the first side in the second direction X. The other two of the pillars 331a are located on opposite ends in the third direction Y of the other pedestal 322a on the second side in the second direction X. Projections 331a1 are formed on respective upper end faces (faces on the first side in the first direction Z) of the pillars 331a.

The third holder 340a is a generally rectangular plate extends in the third direction Y, integrally formed with the lower end (the end on the second side in the first direction Z) of the inner face of the main body 310a. The third holder 340a is provided with a housing recess 341a. An attaching recess 342a is provided in the distal end face (the end face on the first side in the third direction Y) of the third holder 340a, on the first side in the second direction X with respect to the housing recess 341a. Attaching recesses 343a and 344a are provided in spaced relation to each other in the second direction X, on the second side in the second direction X with respect to the housing recess 341a in the distal end face of the third holder 340a. The attaching recess 342a is located on the vertical line passing through the attaching recess 321a1. The attaching recess 343a is located on the vertical line passing through the attaching recess 321a2, and the attaching recess 344a is located on the vertical line passing through the attaching recess 321a3.

As illustrated in FIGS. 2A to 4, the first circuit board 400a is held by the first holder 320a. The first circuit board 400a includes a pair of protrusions 410a, four guide recesses 420a, a plurality of through-hole electrodes 430a, and a plurality of conductive lines (not shown). The protrusions 410a are generally rectangular plates protrude from centers of opposite ends in the second direction X of the first circuit board 400a. The dimension in the third direction Y of each protrusion 410a is substantially the same as the distance between two pillars 331a arranged in the third direction Y. The protrusions 410a are placed on the respective pedestals 322a of the first holder 320a to abut the pillars 331a. That is, the positions of the protrusions 410a are fixed in position by the pillars 331a.

Two of the guide recesses 420a are provided on the first side in the second direction X of the first circuit board 400a, more particularly on opposite sides in the third direction Y of one of the protrusions 410a on the first side in the second direction X. The other two guide recesses 420a are provided on the second side in the second direction X of the first circuit board 400a, more particularly on opposite sides in the third direction Y of the other protrusion 410a on the second side in the second direction X. The guide recesses 420a are of shape corresponding to the outer shapes of the pillars 331a. The pillars 331a fit in the respective guide recesses 420a so as to be movable in the first direction Z.

As illustrated in FIGS. 3A and 3B, three of the through-hole electrodes 430a are arranged at intervals along the second direction X, on a first end portion in the third direction Y of the first circuit board 400a. The rest of the through-hole electrodes 430a are arranged at intervals along the second direction X, on the second end portion in the third direction Y of the first circuit board 400a.

The pair of first circuits 600a is provided on the first circuit board 400a. One of the first circuits 600a (hereinbelow referred to as a first side first circuit 600a) is a protection circuit for the switch S1. The other first circuit 600a (hereinbelow referred to as a second side first circuits 600a) is a protection circuit for the switch S2. The first circuits 600a are electrically connected to the through-hole electrodes 430a via the conductive lines of the first circuit board 400a.

As illustrated in FIGS. 2A to 4, the second circuit board 400b is held by the second holder 330a. The second circuit board 400b is spaced from the first circuit board 400a in the first direction Z. The second circuit board 400b includes a pair of fitting holes 410b, a pair of fitting recesses 420b, a plurality of through-hole electrodes 430b, and a plurality of conductive lines (not shown). The fitting holes 410b are provided at opposite corners of the first side of the third direction Y of the second circuit board 400b. The fitting recesses 420b are provided at opposite corners of the second side of the third direction Y of the second circuit board 400b. The fitting holes 410b and the fitting recesses 420b receive the projections 331a1 of the second holder 330a such that the second circuit board 400b is held on the pillars 331a of the second holder 330a. The second circuit board 400b thus held is located on the first side in the Z direction the first circuit board 400a, with a space therebetween.

Three of the through-hole electrodes 430b are arranged at intervals along the second direction X, on a first end portion in the third direction Y of the second circuit board 400b. The centers of the three thorough-hole electrodes 430b are located above the respective three through-hole electrodes 430a, i.e. on the vertical lines passing through the centers of the respective three through-hole electrodes 430a. The rest of the through-hole electrodes 430b are arranged at intervals along the second direction X, on the second end portion in the third direction Y of the second circuit board 400b. The centers of these through-hole electrodes 430b are located above the respective rest of the through-hole electrodes 430a, i.e. on the vertical lines passing through the centers of the respective rest of the through-hole electrodes 430a.

The electronic components 500a and 500b and the pair of second circuits 600b are provided on the second circuit board 400b. The electronic components 500a and 500b are light emitting diodes (LEDs). One of the second circuits 600b (hereinbelow referred to as a first side second circuit 600b) is an illumination circuit for turning on the electronic component 500a when the switch S1 is turned on. The other second circuit 600b (hereinbelow referred to as a second side second circuit 600b) is an illumination circuit for turning on the electronic component 500b when the switch S2 is turned on. The conductive lines of the second circuit board 400b serve to electrically connect between the electronic components 500a and 500b and the through-hole electrodes 430b, between the electronic components 500a and 500b and the second circuits 600b, and between the through-hole electrodes 430b and the second circuits 600b.

The switch S1 is a normally closed switch. As illustrated in FIGS. 3A to 5B, the switch S1 includes first and second fixed contacts S11 and S12 and a movable contact S13. The first and second fixed contacts S11 and S12 are terminals formed of metal plates. The movable contact S13 is a slider formed of a metal plate.

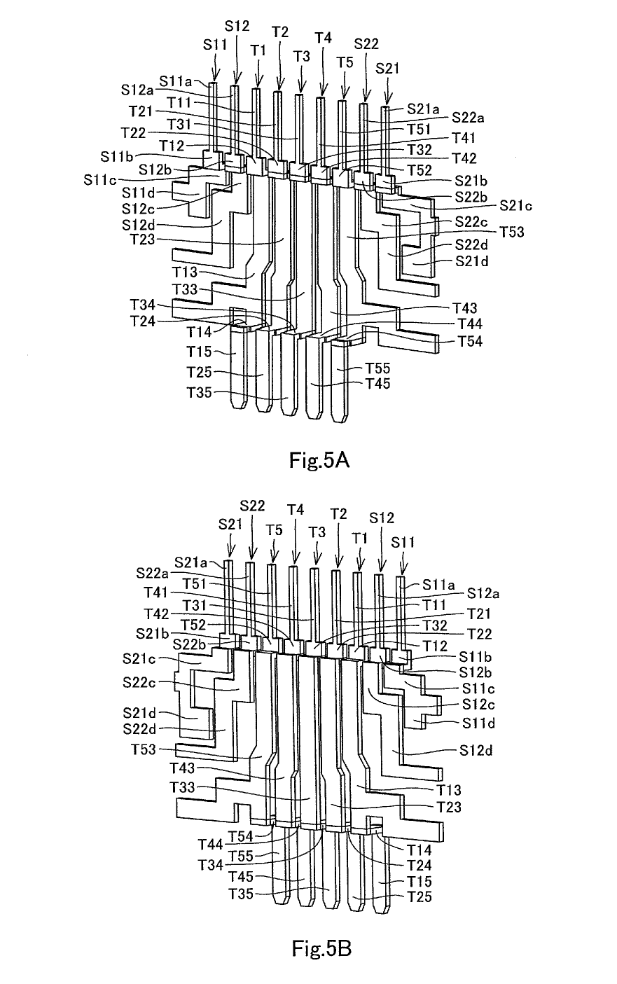

As illustrated in FIGS. 5A and 5B, the first fixed contact S11 includes a connection portion S11a, a bent portion S11b, an embedded portion S11c, and a contact portion S11d. The embedded portion S11c is a generally L-shaped plate consisting of a first plate and a second plate. The first plate of the embedded portion S11c extends in the first direction Z. The second plate of the embedded portion S11c extends contiguously from the lower end of the first plate of the embedded portion S11c to the first side in the second direction X. The embedded portion S11c is embedded in the main body 310a.

The bent portion S11b is a generally L-shaped plate consisting of a first plate and a second plate. The first plate of the bent portion S11b extends contiguously from the upper end (the first end in the first direction Z) of the first plate of the embedded portion S11c to the first side in the third direction Y. The first plate of the bent portion S11b is embedded in the main body 310a. The second plate of the bent portion S11b extends contiguously from the first plate of the bent portion S11b to the first side in the first direction Z. The lower end of the second plate of the bent portion S11b is embedded in the main body 310a. The upper end of the second plate of the bent portion S11b protrudes upward from the main body 310a to be located inside the recess 311a of the main body 310a.

The connection portion S11a is a square pole extending in the first direction Z from the upper end (the first end in the first direction Z) of the second plate of the bent portion S11b. As illustrated in FIG. 4, the connection portion S11a is disposed inside the recess 311a of the main body 310a (but actually outside the body 300a). The connection portion S11a is inserted through and soldered to the corresponding through-hole electrode 430a of the first circuit board 400a and the corresponding through-hole electrode 430b of the second circuit board 400b. The first fixed contact S11 is thus electrically connected to the first and second circuit boards 400a and 400b, the first side first circuit 600a, the first side second circuit 600b, and the electronic component 500a.

The contact portion S11d is a rectangular plate extending contiguously from the second plate of the embedded portion S11c to the lower side (to the second side in the first direction Z). As illustrated in FIGS. 2C and 2D, the contact portion S11d is partially embedded in the main body 310a and partially exposed on the bottom of the recess 312a of the main body 310a.

As illustrated in FIGS. 5A and 5B, the second fixed contact S12 includes a connection portion S12a, a bent portion S12b, an embedded portion S12c, and a contact portion S12d. The embedded portion S12c is a generally L-shaped plate consisting of a first plate and a second plate. The first plate of the embedded portion S12c extends in the first direction Z. The first plate of the embedded portion S12c has a larger dimension in the first direction Z than the first plate of the embedded portion S11c. The second plate of the embedded portion S12c extends contiguously from the first plate of the embedded portion S12c to the first side in the second direction X. The embedded portion S12c is embedded in the main body 310a to be located on the second side in the second direction X with respect to the embedded portion S11c and the contact portion S11d.

The bent portion S12b is a generally L-shaped plate consisting of a first plate and a second plate. The first plate of the bent portion S12b extends contiguously from the upper end (the first end in the first direction Z) of the first plate of the embedded portion S12c to the first side in the third direction Y. The first plate of the bent portion S12b is embedded in the main body 310a so as to be located on the second side in the second direction X with respect to the first plate of the bent portion S11b. The second plate of the bent portion S12b extends contiguously from the first plate of the bent portion S12b to the first side in the Z direction. The lower end of the second plate of the bent portion S12b is embedded in the main body 310a so as to be located on the second side in the second direction X with respect to the lower end of the second plate of the bent portion S11b. The upper end of the second plate of the bent portion S12b protrudes upward from the main body 310a to be located inside the recess 311a of the main body 310a, more particularly on the second side in the second direction X with respect to the upper end of the second plate of the bent portion S11b.

The connection portion S12a is a square pole extending in the first direction Z from the upper end (the first end in the first direction Z) of the second plate of the bent portion S12b. The connection portion S12a is disposed inside the recess 311a of the main body 310a (but actually outside the body 300a) so as to be located on the second side in the second direction X with respect to the connection portion S11a. The connection portion S12a is inserted through and soldered to the corresponding through-hole electrode 430a of the first circuit board 400a and the corresponding through-hole electrode 430b of the second circuit board 400b. The second fixed contact S12 is thus electrically connected to the first and second circuit boards 400a and 400b, the first side first circuit 600a, the first side second circuit 600b, and the electronic component 500a.

The contact portion S12d is a rectangular plate extending contiguously from the second plate of the embedded portion S12c to the lower side (to the second side in the first direction Z). As illustrated in FIGS. 2C and 2D, the contact portion S12d is partially embedded in the main body 310a and partially exposed on the bottom of the recess 312a of the main body 310a. The contact portion S12d is located on the second side in the second direction X with respect to the contact portion S11d. The contact portion S12d is has a larger dimension in the first direction Z than the contact portion S11d. That is, the contact portion S12d extends further than the contact portion S11d to the second side in the first direction Z.

As illustrated in FIGS. 2C to 3B, the movable contact S13 includes a fixed plate S13a, and sliding arms S13b and S13c. The fixed plate S13a is a rectangular plate fixed to the slider 200. The sliding arms S13b and S13c are contiguous with the fixed plate S13a and extend in substantially parallel to each other. Each of the sliding arms S13b and S13c has a distal end curved in an arc shape. The movable contact S13 in an initial position is located as illustrated in FIG. 2C. Particularly, the distal end of the sliding arm S13b is in contact with the contact portion S11d of the first fixed contact S11, and the distal end of the sliding arm S13c is in contact with the contact portion S12d of the second fixed contact S12. In this arrangement, the switch S1 is on to make the first side second circuit 600b glow the electronic component 500a. When the keytop 100 and the slider 200 move, the movable contact S13 accordingly moves from the initial position to a moved position, and the distal ends of the sliding arms S13b and S13c slide along the bottom of the recess 312a. When the movable contact S13 is located at the moved position as illustrated in FIG. 2D, the distal end of the sliding arm S13c maintains the contact with the contact portion S12d of the second fixed contact S12. On the other hand, the distal end of the sliding arm S13b is brought out of contact with the contact portion S11d of the first fixed contact S11. In this arrangement, the switch S1 is turned off to make the first side second circuit 600b turn off the electronic component 500a.

The switch S2 is a normally open switch. As illustrated in FIGS. 3A to 5B, the switch S2 includes first and second fixed contacts S21 and S22, and a movable contact S23. The first and second fixed contacts S21 and S22 are terminals formed of metal plates.

As illustrated in FIGS. 5A and 5B, the first fixed contact S21 has substantially the same shape as the first fixed contact S11, except that an embedded portion S21c and a contact portion S21d of the first fixed contact S21 are different in shape from the embedded portion S11c and the contact portion S11d, respectively, of the first fixed contact S11 of the switch S1. A connection portion S21a is inserted through and soldered to the corresponding through-hole electrode 430a of the first circuit board 400a and the corresponding through-hole electrode 430b of the second circuit board 400b. The first fixed contact S21 is thus electrically connected to the first and second circuit boards 400a and 400b, the second side first circuit 600a, the second side second circuit 600b, and the electronic component 500b. A bent portion S21b of the first fixed contact S21 is illustrated in FIGS. 5A and 5B.

The embedded portion S21c is a plate consisting of a first plate, a second plate, and a third plate. The first plate of the embedded portion S21c extends in the first direction Z. The second plate of the embedded portion S21c extends contiguously from the lower end of the first plate of the embedded portion S21c to the second side in the second direction X. The third plate of the embedded portion S21c extends contiguously from the second end in the second direction X of the second plate of the embedded portion S21c to the lower side (to the second side in the first direction Z). The embedded portion S21c is embedded in the main body 310a.

The contact portion S21d is a rectangular plate extending contiguously from the lower end of the third plate of the embedded portion S21c to the first side in the second direction X. As illustrated in FIGS. 2C and 2D, the contact portion S21d is partially embedded in the main body 310a and partially exposed on the bottom of the recess 313a of the main body 310a.

As illustrated in FIGS. 5A and 5B, the second fixed contact S22 has a generally symmetrical shape to the second fixed contact S12. An embedded portion S22c of the second fixed contact S22 is embedded in the main body 310a so as to be located on the first side in the second direction X with respect to the embedded portion S21c. A bent portion S22b of the second fixed contact S22 is embedded in the main body 310a such that the lower ends of first and second plates are located on the first side in the second direction X with respect to the lower ends of the first and second plates, respectively, of the bent portion S21b. The upper end of the second plate of the bent portion S22b protrudes upward from the main body 310a to be located inside the recess 311a of the main body 310a and on the first side in the second direction X with respect to the upper end of the second plate of the bent portion S21b. A connection portion S22a of the second fixed contact S22 is located inside the recess 311a of the main body 310a (but actually outside the body 300a) and on the first side in the second direction X with respect to the connection portion S21a. The connection portion S22a is inserted through and soldered to the corresponding through-hole electrode 430a of the first circuit board 400a and the corresponding through-hole electrode 430b of the second circuit board 400b. The second fixed contact S22 is thus electrically connected to the first and second circuit boards 400a and 400b, the second side first circuit 600a, the second side second circuit 600b, and the electronic component 500b. As illustrated in FIGS. 2C and 2D, a contact portion S22d of the second fixed contact S22 is partially embedded in the main body 310a and partially exposed on the bottom of the recess 313a of the main body 310a. The contact portion S22d is located on the first side in the second direction X with respect to the contact portion S21d.

As illustrated in FIGS. 2C and 2D, the movable contact S23 has the same configuration as the movable contact S13 of the switch S1. The movable contact S23 in an initial position is located as illustrated in FIG. 2C. Particularly, the distal end of a sliding arm S23c is in contact with the contact portion S22d of the second fixed contact S22. On the other hand, the distal end of a sliding arm S23b is not in contact with the contact portion S21d of the first fixed contact S21. In this arrangement, the switch S2 is off to make the second side second circuit 600b maintains the electronic component 500b in an off state. When the keytop 100 and the slider 200 move, the movable contact S23 accordingly moves from the initial position to a moved position, and the distal ends of the sliding arms S23b and S23c slide along the bottom of the recess 313a. When the movable contact S23 is located at the moved position as illustrated in FIG. 2D, the distal end of the sliding arm S23b is brought into contact with the contact portion S21d of the first fixed contact S21, and the distal end of the sliding arm S23c is brought into contact with and the contact portion S22d of the second fixed contact S22. This arrangement causes the switch S2 to be turned on to make the second side second circuit 600b turn on the electronic component 500b. A fixed plate S23a of the movable contact S23 is illustrated in FIGS. 2C and 2D.

The terminals T1, T2, T3, T4, and T5 are formed of metal plates. As illustrated in FIG. 4, the terminals T1, T2, T3, T4, and T5 are partially embedded at intervals along the second direction X in the main body 310a, between the second fixed contact S12 of the switch S1 and the second fixed contact S22 of the switch S2. In other words, the first fixed contact S11, the second fixed contact S12, the terminals T1, T2, T3, T4, and T5, the second fixed contact S22, and the first fixed contact S21 are arrayed at intervals in this order along the second direction X and partially embedded in the main body 310a.

As illustrated in FIGS. 5A and 5B, the terminal T1 includes a connection portion T11, a first bent portion T12, an embedded portion T13, a second bent portion T14, and a tail portion T15. The first bent portion T12 has the same shape as the bent portion S12b of the second fixed contact S12 of the switch S1. A first plate of the first bent portion T12 is embedded in the main body 310a so as to be located on the second side in the second direction X with respect to the first plate of the bent portion S12b. The lower end of a second plate of the first bent portion T12 is embedded in the main body 310a so as to be located on the second side in the second direction X with respect to the lower end of the second plate of the bent portion S12b. The upper end of the second plate of the first bent portion T12 protrudes upward from the main body 310a to be located inside the recess 311a of the main body 310a, more particularly on the second side in the second direction X with respect to the upper end of the second plate of the bent portion S12b.

The connection portion T11 has the same shape as the connection portion S12a of the second fixed contact S12 of the switch S1. The connection portion T11 is disposed inside the recess 311a of the main body 310a (but actually outside the body 300a) so as to be located on the second side in the second direction X with respect to the connection portion S12a. The connection portion T11 is inserted through and soldered to the corresponding through-hole electrode 430a of the first circuit board 400a and the corresponding through-hole electrode 430b of the second circuit board 400b. The terminal T1 is thus electrically connected to the first and second circuit boards 400a and 400b, the first side second circuit 600b, and the electronic component 500a. The terminal T1 thus forms part of the first side second circuit 600b (illumination circuit) for the electronic component 500a.

The embedded portion T13 is a generally rectangular plate extending contiguously from the first bent portion T12 to the lower side (to the second side in the first direction Z). The embedded portion T13 is embedded in the main body 310a so as to be located on the second side in the second direction X with respect to the embedded portion S12c and the contact portion S12d of the second fixed contact S12. The second bent portion T14 is a rectangular plate extending contiguously from the lower end of the embedded portion T13 to the first side in the third direction Y. The second bent portion T14 is embedded in the main body 310a and the third holder 340a. The tail portion T15 is a generally rectangular plate extending contiguously from the first end in the third direction Y of the second bent portion T14 to the lower side (to the second side in the first direction Z). The tail portion T15 protrudes from the third holder 340a to the lower side (to the second side in the first direction Z).

As illustrated in FIGS. 5A and 5B, the terminal T2 includes a connection portion T21, a first bent portion T22, an embedded portion T23, a second bent portion T24, and a tail portion T25. The first bent portion T22 has the same shape as the bent portion S12b of the second fixed contact S12 of the switch S1. A first plate of the first bent portion T22 is embedded in the main body 310a so as to be located on the second side in the second direction X with respect to the first plate of the first bent portion T12. The lower end of a second plate of the first bent portion T22 is embedded in the main body 310a so as to be located on the second side in the second direction X with respect to the lower end of the second plate of the first bent portion T12. The upper end of the second plate of the first bent portion T22 protrudes upward from the main body 310a to be located inside the recess 311a of the main body 310a, more particularly on the second side in the second direction X with respect to the upper end of the second plate of the first bent portion T12.

The connection portion T21 has the same shape as the connection portion S12a of the second fixed contact S12 of the switch S1. The connection portion T21 is disposed inside the recess 311a of the main body 310a (but actually outside the body 300a) so as to be located on the second side in the second direction X with respect to the connection portion T11. The connection portion T21 is inserted through and soldered to the corresponding through-hole electrode 430a of the first circuit board 400a and the corresponding through-hole electrode 430b of the second circuit board 400b. The terminal T2 is thus electrically connected to the first and second circuit boards 400a and 400b, the first side second circuit 600b, and the electronic component 500a. The terminal T2 thus forms part of the first side second circuit 600b (illumination circuit) for the electronic component 500a.

The embedded portion T23 is a generally rectangular plate extending contiguously from the first bent portion T22 to the lower side (to the second side in the first direction Z). The embedded portion T23 is embedded in the main body 310a so as to be located on the second side in the second direction X with respect to the embedded portion T13 of the terminal T1. The second bent portion T24 is a rectangular plate which is connected to the lower end of the embedded portion T23 and extends toward the first side in the third direction Y. The second bent portion T24 is embedded in the main body 310a and the third holder 340a so as to be located on the second side in the second direction X with respect to the second bent portion T14 of the terminal T1. The tail portion T25 is a generally rectangular plate extending contiguously from the first end in the third direction Y of the second bent portion T24 to the lower side (to the second side in the first direction Z). The tail portion T25 protrudes from the third holder 340a to the lower side (to the second side in the first direction Z). The tail portion T25 is located on the second side in the second direction X with respect to the tail portion T15 of the terminal T1.

As illustrated in FIGS. 5A and 5B, the terminal T3 includes a connection portion T31, a first bent portion T32, an embedded portion T33, a second bent portion T34, and a tail portion T35. The first bent portion T32 has the same shape as the bent portion S12b of the second fixed contact S12 of the switch S1. A first plate of the first bent portion T32 is embedded in the main body 310a so as to be located on the second side in the second direction X with respect to the first plate of the first bent portion T22. The lower end of a second plate of the first bent portion T32 is embedded in the main body 310a so as to be located on the second side in the second direction X with respect to the lower end of the second plate of the first bent portion T22. The upper end of the second plate of the first bent portion T32 protrudes upward from the main body 310a to be located inside the recess 311a of the main body 310a, more particularly, on the second side in the second direction X with respect to the upper end of the second plate of the first bent portion T22.

The connection portion T31 has the same shape as the connection portion S12a of the second fixed contact S12 of the switch S1. The connection portion T31 is disposed inside the recess 311a of the main body 310a (but actually outside the body 300a) so as to be located on the second side in the second direction X with respect to the connection portion T21. The connection portion T31 is inserted through and soldered to the corresponding through-hole electrode 430a of the first circuit board 400a and the corresponding through-hole electrode 430b of the second circuit board 400b. The terminal T3 is thus electrically connected to the first and second circuit boards 400a and 400b, the first side first circuit 600a, and the electronic component 500a. The terminal T3 thus forms part of the first side first circuit 600a (protection circuit) for the switch S1.

The embedded portion T33 is a generally rectangular plate extending contiguously from the first bent portion T32 to the lower side (to the second side in the first direction Z). The embedded portion T33 is embedded in the main body 310a so as to be located on the second side in the second direction X with respect to the embedded portion T23 of the terminal T2. The second bent portion T34 is a rectangular plate extending contiguously from the lower end of the embedded portion T33 to the first side in the third direction Y. The second bent portion T34 is embedded in the main body 310a and the third holder 340a so as to be located on the second side in the second direction X with respect to the second bent portion T24 of the terminal T2. The tail portion T35 is a generally rectangular plate extending contiguously from the first end in the third direction Y of the second bent portion T34 to the lower side (to the second side in the first direction Z). The tail portion T35 protrudes from the third holder 340a to the lower side (to the second side in the first direction Z). The tail portion T35 is located on the second side in the second direction X with respect to the tail portion T25 of the terminal T2.

As illustrated in FIGS. 5A and 5B, the terminal T4 has a generally symmetrical shape to the terminal T2. A first plate of a first bent portion T42 of the terminal T4 is embedded in the main body 310a so as to be located on the second side in the second direction X with respect to the first plate of the first bent portion T32. The lower end of a second plate of the first bent portion T42 is embedded in the main body 310a so as to be located on the second side in the second direction X with respect to the lower end of the second plate of the first bent portion T32. The upper end of the second plate of the first bent portion T42 protrudes upward from the main body 310a to be located inside the recess 311a of the main body 310a, more particularly on the second side in the second direction X with respect to the upper end of the second plate of the first bent portion T32.

A connection portion T41 of the terminal T4 is disposed inside the recess 311a of the main body 310a (but actually outside the body 300a) so as to be located on the second side in the second direction X with respect to the connection portion T31. The connection portion T41 is inserted through and soldered to the corresponding through-hole electrode 430a of the first circuit board 400a and the corresponding through-hole electrode 430b of the second circuit board 400b. The terminal T4 is thus electrically connected to the first and second circuit boards 400a and 400b, the first side first circuit 600a, and the electronic component 500a. The terminal T4 thus forms part of the first side first circuit 600a (protection circuit) for the switch S1.

An embedded portion T43 of the terminal T4 is embedded in the main body 310a so as to be located on the second side in the second direction X with respect to the embedded portion T33 of the terminal T3. A second bent portion T44 of the terminal T4 is embedded in the main body 310a and the third holder 340a so as to be located on the second side in the second direction X with respect to the second bent portion T34 of the terminal T3. A tail portion T45 of the terminal T4 protrudes from the third holder 340a to the lower side (to the second side in the first direction Z). The tail portion T45 is located on the second side in the second direction X with respect to the tail portion T35 of the terminal T3.

As illustrated in FIGS. 5A and 5B, the terminal T5 has a generally symmetrical shape to the terminal T1. A first plate of a first bent portion T52 of the terminal T5 is embedded in the main body 310a so as to be located on the second side in the second direction X with respect to the first plate of the first bent portion T42. The lower end of a second plate of the first bent portion T52 is embedded in the main body 310a so as to be located on the second side in the second direction X with respect to the lower end of the second plate of the first bent portion T42. The upper end of the second plate of the first bent portion T52 protrudes upward from the main body 310a to be located inside the recess 311a of the main body 310a, more particularly on the second side in the second direction X with respect to the upper end of the first plate of the first bent portion T42.

A connection portion T51 of the terminal T5 is disposed inside the recess 311a of the main body 310a (but actually outside the body 300a) so as to be located on the second side in the second direction X with respect to the connection portion T41. The connection portion T51 is inserted through and soldered to the corresponding through-hole electrode 430a of the first circuit board 400a and the corresponding through-hole electrode 430b of the second circuit board 400b. The terminal T5 is thus electrically connected to the first and second circuit boards 400a and 400b, the second side first circuit 600a and the electronic component 500b. The terminal T5 thus forms part of the first side first circuit 600a (protection circuit) for the switch S2.

An embedded portion T53 of the terminal T5 is embedded in the main body 310a so as to be located on the second side in the second direction X with respect to the embedded portion T43 of the terminal T4. A second bent portion T54 of the terminal T5 is embedded in the main body 310a and the third holder 340a so as to be located on the second side in the second direction X with respect to the second bent portion T44 of the terminal T4. A tail portion T55 of the terminal T5 protrudes from the third holder 340a to the lower side (to the second side in the first direction Z). The tail portion T55 is located on the second side in the second direction X with respect to the tail portion T45 of the terminal T4.

The terminal T6 is a metal plate as illustrated in FIGS. 3A to 4. The terminal T6 includes a connection portion T61, a first bent portion T62, a fixed portion T63, a second bent portion T64, and a tail portion T65. The fixed portion T63 is a rectangular plate extending in the first direction Z. The fixed portion T63 is welded to a boss on the inner face of the main body 310a. The first bent portion T62 is a generally L-shaped plate consisting of a first plate and a second plate. The first plate of the first bent portion T62 extends contiguously from the upper end of the fixed portion T63 to the first side in the third direction Y. The second plate of the first bent portion T62 extends contiguously from the first plate of the first bent portion T62 to the upper side (to the first side in the first direction Z). The second plate of the first bent portion T62 fits in the attaching recess 321a1 of the first holder 320a.

The connection portion T61 is a square pole extending to the first side in the first direction Z from the upper end (the first end in the first direction Z) of the second plate of the first bent portion T62. The connection portion T61 is inserted through and soldered to the corresponding through-hole electrode 430a of the first circuit board 400a and the corresponding through-hole electrode 430b of the second circuit board 400b. The terminal T6 is thus electrically connected to the first and second circuit boards 400a and 400b, the second side first circuit 600a, and the electronic component 500b. The terminal T6 thus forms part of the second side first circuit 600a (protection circuit) for the switch S2.

The second bent portion T64 is a generally L-shaped plate consisting of a first plate and a second plate. The first plate of the second bent portion T64 extends contiguously from the lower end of the fixed portion T63 to the first side in the third direction Y. The second plate of the second bent portion T64 extends contiguously from the first plate of the second bent portion T64 to the lower side (to the second side in the first direction Z). The second plate of the second bent portion T64 fits in the attaching recess 342a of the third holder 340a. The tail portion T65 is a generally rectangular plate extending contiguously from the first end in the third direction Y of the second bent portion T64 to the lower side (to the second side in the first direction Z).

As illustrated in FIGS. 3A to 4, the terminals T7 and T8 are each a metal plate of the same shape as the terminal T6. As illustrated in FIGS. 5A and 5B, the terminal T7 includes a connection portion T71, a first bent portion T72, a fixed portion T73, a second bent portion T74, and a tail portion T75. Similarly, the terminal T8 includes a connection portion T81, a first bent portion T82, a fixed portion T83, a second bent portion T84, and a tail portion T85. The fixed portions T73 and T83 are welded to bosses on the inner face of the main body 310a. A second plate of the first bent portion T72 and a second plate of the first bent portion T82 fit in the attaching recess 321a2 and the attaching recess 321a3, respectively, of the first holder 320a. A second plate of the second bent portion T74 and a second plate of the second bent portion T84 fit in the attaching recess 343a and the attaching recess 344a, respectively, of the third holder 340a. The connection portions T71 and T81 are inserted through and soldered to the corresponding through-hole electrodes 430a of the first circuit board 400a and the corresponding through-hole electrodes 430b of the second circuit board 400b. The terminals T7 and T8 are thus electrically connected to the first and second circuit boards 400a and 400b, the second side second circuit 600b, and the electronic component 500b. The terminals T7 and T8 thus form part of the second side second circuit 600b (illumination circuit) for the electronic component 500b.

The case 300b is attached to the body 300a. The case 300b is made of insulating plastic material. As illustrated in FIGS. 3A and 3B, the case 300b includes a case body 310b and a connection portion 320b. The case body 310b includes a front plate 311b, a pair of side plates 312b, a bottom plate 313b, and a support base 314b.

The bottom plate 313b is a generally rectangular plate. The bottom plate 313b has a rectangular through-hole 313b1. The front plate 311b of a rectangular shape stands on the front end (the first end in the third direction Y) of the upper face of the bottom 313b. A pair of rails 311b1 is provided in spaced relation to each other in the second direction X on the inner face of the front plate 311b. The rails 311b1 are elongated protrusions extending in the first direction Z. The side plates 312b of generally rectangular shape stand on opposite ends (opposite ends in the second direction X) of the upper face of the bottom plate 313b. The front ends (the ends on the first side in the third direction Y) of the side plates 312b are integral with the opposite ends in the second direction X of the front plate 311b. The distance between the inner faces of the side plates 312b is substantially the same as the dimension in the second direction X of the main body 310a, and as the dimension in the second direction X of the slider 200. The inner faces of the side plate 312b are each provided with a rail groove 312b1 extending in the first direction Z. The rear portions of the side plates 312 are each provided with a plurality of locking holes. These locking holes receive locking claws on opposite ends in the second direction X of the main body 310a to attach the case body 310b to the main body 310a. In this combined state as illustrated in FIGS. 2A to 2D, the third holder 340a of the body 300a closes the through-hole 313b1 of the bottom plate 313b. As illustrated in FIG. 3B, the case body 310b, the main body 310a, and the third holder 340a define a first housing space α1. The first housing space α1 houses the slider 200, the movable contact S13 of the switch S1, the movable contact S23 of the switch S2, and the coil spring 800.

As illustrated in FIGS. 2C and 2D, the support base 314b is provided on the bottom plate 313b at a position on the first side in the third direction Y with respect to the through-hole 313b1. The support base 314b has a housing recess 314b1 communicating with the housing recess 341a of the third holder 340a. The housing recesses 341a and 314b1 securely house a first lengthwise end of the coil spring 800.

As illustrated in FIGS. 2A to 2D, the connection portion 320b is a generally square tube on the lower face of the bottom plate 313b. The connection portion 320b is connectable to a mating connector (not shown). An opening 321b is provided on the second side in the third direction Y of the connection portion 320b. The opening 321b allows the tail portions T15 to T85 of the terminals T1 to T8 into the connection portion 320b. The tail portions T15 to T85 are electrically connectable to contacts of the mating connector.

The slider 200 is held by the case 300b so as to be slidable in the first direction Z between an home position and a depressed position (both to be described). As illustrated in FIGS. 3A and 3b, the slider 200 includes a ceiling 210, a front plate 220, a pair of side plates 230, a bottom 240, and a cushion 250. The slider 200, exclusive of the cushion 250, is made of insulating plastic material.

The front plate 220 is a generally rectangular plate. The side plates 230 are rectangular plates extending contiguously from opposite ends in the second direction X of the front plate 220 to the second side in the third direction Y. The bottom 240 is provided on the lower parts of the inner faces of the front plate 220 and the side plates 230. The ceiling 210 is a generally rectangular cup-shaped member on the upper ends of the front plate 220 and the side plates 230. As illustrated in FIG. 3B, the ceiling 210, the front plate 220, the side plates 230, and the bottom 240 define a second housing space a2. The second housing space a2 houses the first and second holders 320a and 330a, the first and second circuit boards 400a and 400b, the electronic components 500a and 500b, the terminals T6 to T8, and a ball 920 and a coil spring 930 (both to be described) of the tactile feel generator 900.

As illustrated in FIG. 3A, rail grooves 221 extend in the first direction Z on opposite end portions in the second direction X of the outer face of the front plate 220. The outer face of each side plate 230 is provided with a rail 231 extending in the first direction Z. The rails 231 fit in the respective rail grooves 312b1 of the case 300b so as to be movable in the first direction Z. The rails 311b1 of the case 300b fit in the respective rail grooves 221 so as to be movable in the first direction Z. The slider 200 is thus movable between the home position and the depressed position.

A rectangular through-hole 222 is provided centrally in the center of the front plate 220. As illustrated in FIGS. 2A and 2B, the though hole 222 receives the stop 323a of the first holder 320a. Also, as illustrated in FIG. 3A, a pair of attaching grooves 223 extends in the first direction Z under the through-hole 222 on the front plate 220. The attaching grooves 223 communicate with the thorough-hole 222 at each first end in the first direction Z. The second ends of the attaching grooves 223 open to the second side in the first direction Z. The attaching grooves 223 receive end portions in the second direction X of the cushion 250. The cushion 250 is a generally rectangular frame. When the slider 200 is located at the home position as illustrated in FIG. 2A, the cushion 250 elastically abuts the stop 323a of the first holder 320a. When the slider 200 is located at the depressed position as illustrated in FIG. 2B, the cushion 250 elastically abuts the support base 314b of the case 300b.

The ceiling 210 has a hole 211. As illustrated in FIGS. 2A and 2B, the hole 211 is located so as to face the electronic components 500a and 500b. The hole 211 thus passes light emitted by the electronic components 500a and 500b to the first side in the first direction Z.

As illustrated in FIGS. 3A and 3B, a rectangular housing recess 241 is provided in the lower center of the bottom 240. The housing recess 241 has larger dimensions that the outer dimensions of the support base 314b of the case 300b. As illustrated in FIG. 2B, when the slider 200 is located at the depressed position, the housing recess 241 houses the support base 314b. A columnar projection 242 is provided on the bottom of the housing recess 241. The projection 242 faces the housing recesses 341a and 314b1. The outer diameter of the projection 242 is slightly smaller than the inner diameter of the coil spring 800. The projection 242 fits in a second lengthwise end of the coil spring 800 that is securely housed in the housing recesses 341a and 314b1. When the slider 200 is located at the depressed position, the coil spring 800 is compressed between the bottom of the housing recess 241 (the bottom 240) and the bottoms of the housing recesses 341a and 314b1. The compresses coil spring 800 applies a returning force to the slider 200 to return to the home position.

As illustrated in FIG. 3B, the bottom 240 is provided with bosses 243 on each end portion in the second direction X of the face on the second side in the third direction Y. The bosses 243 are adapted for welding thereto the fixed plates S13a of the movable contact S13 of the switch S1 and the fixed plate S23a of the movable contact S23 of the switch S2. When the slider 200 is located at the home position, the movable contact S13 of the switch S1 and the movable contact S23 of the switch S2 are located at their respective initial positions. When the slider 200 is located at the depressed position, the movable contact S13 of the switch S1 and the movable contact S23 of the switch S2 are located at their respective moved positions. A recess is centrally provided in the face on the second side in the third direction Y of the bottom 240. The bottom of the recess has a columnar housing hole 244.

As illustrated in FIGS. 2A to 3B, the keytop 100 fixedly covers the ceiling 210 of the slider 200. The keytop 100 is movable in the first direction Z, together with the slider 200, with respect to the body 300a and the case 300b. The keytop 100 includes the P mark 110, an opening 120, and a mounting portion 130. The P mark 110 is made of a translucent material. As illustrated in FIGS. 2A and 2B, the opening 120 is provided on the first side in the third direction Y with respect to the P mark 110. The opening 120 has a shape conforming to the outer shape of a fitting protrusion 710a (to be described) of the lens 700a. As illustrated in FIGS. 2A to 2D, the mounting portion 130 is a recess under the P mark 110, with a shape conforming to the outer shape of the light shield block 700b.

The lens 700a includes the fitting protrusion 710a to fit in the opening 120. The lens 700a is disposed above the electronic component 500a. The lens 700a directs light emitted from the electronic component 500a to the outside of the keytop 100.

The light shield block 700b is a generally rectangular frame that is made of a material having a light shielding property and includes a shield plate 710b. The light shield block 700b fits in the mounting portion 130, and the inside of the light shield block 700b is located above the electronic component 500b. The shield plate 710b is located between the electronic component 500a and the electronic component 500b. This arrangement allows light emitted from the electronic component 500b to pass through the light shield block 700b and illuminate the P mark 110 of the keytop 100. On the other hand, the light is blocked by the light shield block 700b and the shield plate 710b so as not to leak to the lens 700a side. Similarly, light emitted from the electronic component 500a is also blocked by the light shield block 700b and the shield plate 710b so as not to leak to the P mark 110 side.

As illustrated in FIGS. 2A to 2D, the tactile feel generator 900 includes an elongated ridge 910, the ball 920, and the coil spring 930. The elongated ridge 910 extends in the first direction Z on the inner face of the main body 310a, between the first holder 320a and the third holder 340a. The elongated ridge 910 faces the housing hole 244 in the bottom 240 of the slider 200. The elongated ridge 910 has a step 911. The outer diameter of the coil spring 930 is slightly smaller than the diameter of the housing hole 244 of the slider 200. The length of the coil spring 930 is larger than the depth of the housing hole 244. Accordingly, the coil spring 930 is housed at its first lengthwise end in the housing hole 244 and protrudes at its second lengthwise end from the housing hole 244. The diameter of the ball 920 is slightly larger than the outer diameter of the coil spring 930. The ball 920 partially fits in the second lengthwise end of the coil spring 930. The sum of the diameter of the ball 920 and the length of the coil spring 930 is larger than the distance in the third direction Y between the bottom of the housing hole 244 and the elongated ridge 910. This arrangement results in that the coil spring 930 elastically presses the ball 920 against the elongated ridge 910. When the slider 200 moves from the home position to the depressed position, the ball 920 climbs over the step 911 of the elongated ridge 910. As a result, a tactile feel is generated in the depressing operation of the keytop 100.

The push switch configured as described above may be manufactured in the following steps. The first step is to prepare the first and second fixed contacts S11 and S12 of the switch S1, the terminals T1 to T5, and the first and second fixed contacts S21 and S22 of the switch S2. Then, the following parts are placed at intervals into a mold (not shown): (1) the bent portions, the embedded portions and the contact portions of the first and second fixed contacts S11 and S12, (2) the first bent portions, the second bent portions and the embedded portions of the terminals T1 to T5, and (3) the bent portions, the embedded portions and the contact portions of the first and second fixed contacts S21 and S22. Particularly, the first fixed contact S11, the second fixed contact S12, the terminals T1, T2, T3, T4 and T5, the second fixed contact S22, and the first fixed contact S21 are arrayed in this order at intervals along the second direction X. Plastic material is poured into the mold to embed the above mentioned parts (1) to (3) in the plastic material. The plastic material hardens to form the main body 310a, the first, second and third holders 320a, 330a and 340a of the body 300a, and the elongated ridge 910.

More particularly, the above parts (1) to (3) are insert molded in the main body 310a of the body 300a. The connection portions of the first and second fixed contacts S11 and S12, the connection portions of the terminals T1 to T5, and the connection portions of the first and second fixed contacts S21 and S22 are disposed inside the recess 311a of the main body 310a. The contact portions of the first and second fixed contacts S11 and S12 are exposed from the recess 312a of the main body 310a, and the contact portions of the first and second fixed contacts S21 and S22 are exposed from the recess 313a of the main body 310a. The second bent portions of the terminals T1 to T5 are insert-molded in the main body 310a and the third holder 340a of the body 300a.

Next, the terminals T6 to T8 are prepared. The first bent portions of the terminals T6 to T8 are fitted into the associated attaching recesses 321a1 to 321a3 of the first holder 320a. The second bent portions of the terminals T6 to T8 are fitted into the associated attaching recesses 342a to 344a of the third holder 340a. The fixed portions of the terminals T6 to T8 thus come into contact with the inner face of the main body 310a. The fixed portions of the terminals T6 to T8 are fixed to the bosses on the inner face of the main body 310a.

Next, the first circuit board 400a with the first circuits 600a is prepared. The guide recesses 420a of the first circuit board 400a are fitted over the associated pillars 331a of the second holder 330a. Accordingly, the pair of protrusions 410a of the first circuit board 400a comes into contact with the pillars 331a. The first circuit board 400a in this state is moved to the second side in the first direction Z along the pillars 331a. Accordingly, the protrusions 410a of the first circuit board 400a are placed on the respective pedestals 322a of the first holder 320a and securely positioned by the pillars 331a. Also, the through-hole electrodes 430a of the first circuit board 400a receive therethrough (a) the connection portions of the first and second fixed contacts S11 and S12, (b) the connection portions of the terminals T1 to T5, (c) the connection portions of the first and second fixed contacts S21 and S22, and (d) the connection portions of the terminals T6 to T8 (i.e. these connection portions pass through the first circuit board 400a). Then, these connection portions (a) to (d) are soldered to the associated through-hole electrodes 430a of the first circuit board 400a. As a result, the first circuits 600a on the first circuit board 400a are electrically connected to the first and second fixed contacts S11 and S12 of the switch S1, the first and second fixed contacts S21 and S22 of the switch S2, and the terminals T3 to T6.

Next, the second circuit board 400b with the second circuits 600b and the electronic components 500a and 500b is prepared. The projections 331a1 of the pillars 331a are fitted in the pair of fitting holes 410b and the pair of fitting recesses 420b of the second circuit board 400b. Accordingly, the second circuit board 400b is held on the pillars 331a of the second holder 330a. Also, the through-hole electrodes 430b of the second circuit board 400b receive therethrough the above connection portions (a) to (d) (i.e. these connection portions pass through the second circuit board 400b). Then, these connection portions (a) to (d) are soldered to the associated through-hole electrodes 430b of the second circuit board 400b. As a result, the first side second circuit 600b and the electronic component 500a on the second circuit board 400b are electrically connected to the first and second fixed contacts S11 and S12 of the switch S1 and to the terminals T1 and T2. The second side second circuit 600b and the electronic component 500b on the second circuit board 400b are electrically connected to the first and second fixed contacts S21 and S22 of the switch S2 and to the terminals T7 and T8. The electronic component 500a is electrically connected also to the terminals T3 and T4. The electronic component 500b is electrically connected also to the terminals T5 and T6.

The keytop 100, the lens 700a, and the light shield block 700b are also prepared. The fitting protrusion 710a of the lens 700a is fitted into the opening 120 of the keytop 100, while the light shield block 700b is fitted into the mounting portion 130 of the keytop 100. Then, the slider 200 is prepared. The cushion 250 fits in the attaching groove 222 of the slider 200. The movable contacts S13 and S23 are also prepared. The fixed plates S13a of the movable contact S13 and the fixed plate S23a of the movable contact S23 are fixed to the bosses 243 of the slider 200. The keytop 100 is then attached to the slider 200.

The case 300b is also prepared. The rails 231 of the slider 200 are fitted into the associated rail grooves 312b1 of the case 300b, and the rails 311b1 of the case 300b are fitted into the associated rail grooves 221 of the slider 200. Accordingly, the slider 200 is attached to the case 300b in a movable manner in the first direction Z. The coil spring 800 is also prepared. The first lengthwise end of the coil spring 800 is partially housed inside the housing recess 314b1 of the case 300b. The slider 200 is then moved to the second side in the first direction Z relative to the case 300b to insert the projection 242 of the slider 200 into the second lengthwise end of the coil spring 800.

The ball 920 and the coil spring 930 are also prepared. The first lengthwise end of the coil spring 930 is housed in the housing hole 244 of the slider 200, while the ball 920 is fitted into the second lengthwise end of the coil spring 930. In this state, the case 300b is fixed to the main body 310a of the body 300a, resulting in the following arrangement. The third holder 340a of the body 300a closes the thorough-hole 313b1 of the bottom plate 313b of the case 300b. The first lengthwise end of the coil spring 800 is partially housed in the housing recess 341a of the bottom plate 313b. The first housing space α1 of the case 300b houses the slider 200, the movable contacts S13 and S23, and the coil spring 800. The second housing space α2 of the slider 200 houses the first and second holders 320a and 330a, the first and second circuit boards 400a and 400b, the electronic components 500a and 500b, the terminals T6 to T8, the ball 920, and the coil spring 930. The ball 920 abuts the elongated ridge 910 of the body 300a, and the coil spring 930 is compressed between the ball 920 and the bottom of the housing hole 244. The stop 323a of the first holder 320a is received in the through-hole 222 of the slider 200. The tail portions T15 to T85 of the terminals T1 to T8 are received into the connection portion 320b through the opening 321b of the case 300b. In this manner, the push switch is fabricated.

The push switch may operate in the following manner. When the keytop 100 and the slider 200 are located at their home positions, the movable contact S13 of the switch S1 is located at its initial position, and the movable contact S23 of the switch S2 is located at its initial position. More particularly, the sliding arm S13b and the sliding arm S13c of the movable contact S23 are in contact with the first fixed contact S11 and the second fixed contact S12, respectively, while the sliding arm S23b of the movable contact S23 is not in contact with the contact portion S21d of the first fixed contact S21. Therefore, the first and second fixed contacts S11 and S12 are electrically connected (the switch S1 is on), so that the associated second circuit 600b on the second circuit board 400b allows the electronic component 500a to glow. On the other hand, the first and second fixed contacts S21 and S22 are not electrically connected (the switch S2 is off), so that the associated second circuit 600b on the second circuit board 400b maintains the electronic component 500b in an off state. Light emitted from the electronic component 500a emits to the outside of the keytop 100 through the lens 700a.

When the keytop 100 is depressed, the rails 231 of the slider 200 are guided along the associated rail grooves 312b1 of the case 300b, and the rails 311b1 of the case 300b are guided along the associated rail grooves 221 of the slider 200. The keytop 100 and the slider 200 thus move in the first direction Z from the home positions to the depressed positions relative to the case 300b. The movable contact S13 of the switch S1 accordingly moves from the initial position to the moved position, and the movable contact S23 of the switch S2 moves from the initial position to the moved position. When the movable contact S13 of the switch S1 is located at the moved position, the distal end of the sliding arm S13b of the movable contact S13 is brought out of contact with the contact portion S11d of the first fixed contact S11. This electrically disconnects the first and second fixed contacts S11 and S12 (the switch S1 is turned off), and the associated second circuit 600b on the second circuit board 400b turns off the electronic component 500a. When the movable contact S23 of the switch S2 is located at the moved position, the distal end of the sliding arm S23b and the distal end of the sliding arm S23c of the movable contact S23 come into contact with the contact portion S21d of the first fixed contact S21 and the contact portion S22d of the second fixed contact S22, respectively. This establishes electrical connection between the first and second fixed contacts S21 and S22 (the switch S2 is turned on), and the associated second circuit 600b on the second circuit board 400b turns on the electronic component 500b. Light emitted from the electronic component 500b illuminates the P mark 110 of the keytop 100.

When the keytop 100 and the slider 200 move from the home positions to the depressed positions, the ball 920 climbs over the step 911 of the elongated ridge 910 of the body 300a. As a result, a tactile feel is generated in the depressing operation of the keytop 100. The cushion 250 elastically abuts the support base 314b of the case 300b to reduce the impact to the slider 200 during the pressing operation of the keytop 100. The coil spring 800 is compressed between the bottom 240 of the slider 200 and the bottoms of the housing recesses 341a and 314b1 to apply a returning force to the slider 200 to return to the home position.

When the keytop 100 is released from the depressing operation, the biasing force of the coil spring 800 causes the rails 231 of the slider 200 to be guided along the associated rail grooves 312b1 of the case 300b and the rails 311b1 of the case 300b to be guided along the associated rail grooves 221 of the slider 200. The slider 200 is thereby pushed up from the depressed position to the home position. The movable contact S13 of the switch S1 accordingly returns from the moved position to the initial position, and the movable contact S23 of the switch S2 returns from the moved position to the initial position. As a result, the push switch is brought back to the original state as described above, i.e. the switch S1 is on, the switch S2 is off, the electronic component 500a is on, and the electronic component 500b is off. Accordingly, the cushion 250 elastically abuts the stop 323a of the first holder 320a to reduce the impact to the slider 200 during the return of the keytop 100 to the home position.

The push switch as described above has the following technical features. Firstly, the push switch can be downsized due to the following arrangement. The first circuit board 400a is provided with the first circuits 600a for protecting the switches S1 and S2, and the second circuit board 400b is provided with the electronic components 500a and 500b and the second circuits 600b. The first circuit board 400a and the second circuit board 400b are held in spaced relation to each other along the first direction Z by the first holder 320a and the second holder 330a of the body 300a. This arrangement can reduce the projected area from the first direction Z of the body 300a and the case 300b as combined.

Secondly, the above push switch has high versatility due to the following arrangement. The electronic components 500a and 500b, and the second circuits 600b are provided in the second circuit board 400b. Therefore, by removing the second circuit board 400b, the push switch can be modified to a push switch that does not require the electronic components 500a and 500b, and the second circuits 600b. Alternatively, by replacing the second circuit board 400b with another second circuit board provided with a different electronic component and a different second circuit for actuating the electronic component, the push switch can also be applied to a push switch for such a different electronic component.

Thirdly, the push switch is easy to manufacture due to the following arrangement. When making the first and second holders 320a and 330a hold the first and second circuit boards 400a and 400b, these circuit boards are electrically connected to the connection portions S11a, S12a, S21a and S22a of the first and second fixed contacts S11, S12, S21, and S22 of the switches S1 and S2, and to the connection portions T11 to T18 of the terminals T1 to T8. Specifically, when making the first holder 320a hold the first circuit board 400a, the connection portions S11a, S12a, S21a and S22a of the first and second fixed contacts S11, S12, S21, and S22 of the switches S1 and S2, and the connection portions T11 to T18 of the terminals T1 to T8 are inserted through and electrically connected to the associated through-hole electrodes 430a of the first circuit board 400a. Also, when making the second holder 330a hold the second circuit board 400b, the connection portions S11a, S12a, S21a and S22a of the first and second fixed contacts S11, S12, S21, and S22 of the switches S1 and S2, and the connection portions T11 to T18 of the terminals T1 to T8 are inserted through and electrically connected to the associated through-hole electrodes 430b of the second circuit board 400b. Therefore, the above arrangement can make it possible to fix the first and second circuit boards 400a and 400b in position with respect to the body 300a and simultaneously to establish electrical connection of the first and second circuit boards 400a and 400b to the first and second fixed contacts S11, S12, S21, and S22 and the terminals T1 to T8.

Fourthly, it is easy to place and fix the first circuit board 400a in position on the first holder 320a. This is because the first circuit board 400a is guided along the pillars 331a of the second holder 330a and then placed on the first holder 320a.

It should be noted that the push switch of the invention is not limited to the above embodiment but can be modified in any manner within the scope described in the appended claims. Specific modifications will be described below.

The slider 200 of the above embodiment is held by the case 300b so as to be slidable in the first direction Z between the home position and the depressed position. However, the slider of the invention can be modified in any manner as long as it is held by at least one of the case and the body so as to be movable in the first direction.

The keytop 100 of the above embodiment is attached to the slider 200. However, the keytop can be modified in any manner as long as it is movable in the first direction. For example, the keytop of the invention can be integrally formed with the slider.

The push switch of the above embodiment is provided with the normally closed switch S1 and the normally open switch S2. However, the push switch of the invention is only required to include at least one of a normally closed switch and a normally open switch.

The switch S1 of the above embodiment includes the first and second fixed contacts S11 and S12 formed of metal plates, and the movable contact S13 which is a slider formed of a metal plate. Further, the switch S2 includes the first and second fixed contacts S21 and S22 formed of metal plates, and the movable contact S23 which is a slider formed of a metal plate. However, the invention requires at least one switch that can turn on or off in response to the movement of the keytop. For example, each switch may be a tactile switch to be mounted on the first circuit board or the second circuit board. The tack switch may be turned on or off when depressed by the keytop or the slider moving in the first direction. Further, each switch may include first and second fixed contacts mounted on the first circuit board or the second circuit board, and a snap plate in contact with the first fixed contact. In this case, the snap plate may be brought into contact with the second fixed contact when depressed by the keytop or the slider moving in the first direction.

In the above embodiment, the contact portion S11d of the first fixed contact S11 and the contact portion S12d of the second fixed contact S12 are exposed from the bottom of the recess 312a of the main body 310a. Further, the contact portion S21d of the first fixed contact S21 and the contact portion S22d of the second fixed contact S22 are exposed from the bottom of the recess 313a of the main body 310a. However, the contact portions of the first and second fixed contacts of the invention may be exposed from the inner face of the main body.

In the above embodiment, the connection portion S11a of the first fixed contact S11 and the connection portion S12a of the second fixed contact S12 are disposed inside the recess 311a of the main body 310a. The connection portion S21a of the first fixed contact S21 and the connection portion S22a of the second fixed contact S22 are also disposed inside the recess 311a of the main body 310a. However, the connection portions of the first and second fixed contacts of the invention may be disposed outside the body and pass through the first and second circuit boards. The embedded portions of the first and second fixed contacts can be modified in any manner as long as they are embedded in the main body. The bent portions of the first and second fixed contacts may be of an L shape or any other shape with a bent that allows the connection portions to pass through the first and second circuit boards.

In the above embodiment, the movable contact S13 includes the fixed plate S13a, and the sliding arms S13b and S13c. Further, the movable contact S23 includes the fixed plate S23a, and the sliding arms S23b and S23c. However, the invention requires at least one movable contact that has the first or second configuration as follows. The first configuration is such that a movable contact is not in contact with at least one of the first and second fixed contacts at its initial position and moves from the initial position in response to the movement of the keytop to make contact with the first and second fixed contacts. The second configuration is such that a movable contact is in contact with the first and second fixed contacts at its initial position and moves from the initial position in response to the movement of keytop so as to be brought out of contact with at least one of the first and second fixed contacts.

The second circuit board 400b of the above embodiment is provided thereon with the electronic components 500a and 500b and the second circuits 600b. However, the second circuit board of the invention can be modified in any manner as long as it is provided thereon with at least one electronic component and a second circuit for actuating the electronic component in response to turn-on or turn-off of the switch. The electronic components 500a and 500b may be LEDs as in the above embodiment or may be of any other kind. For example, the electronic component(s) may be a microphone or a speaker.

The second circuit board 400b of the above embodiment is provided with the fitting holes 410b and the fitting recesses 420b. The second circuit board of the invention may be of any configuration adapted to be held by the second holder of the body in spaced relation to the first circuit board in the first direction.

The first circuit board 400a of the above embodiment is provided with the protrusions 410a and the guide recesses 420a. However, the first circuit board of the invention may be of any shape adapted to be held by the first holder of the body. For example, the first circuit board may be provided with at least one guide recess only in which the pillars of the second holder fit so as to be movable in the first direction.

The body 300a of the above embodiment includes the main body 310a, the first holder 320a, the second holder 330a, and the third holder 340a. However, the body of the invention can be any body including a main body, a first holder provided at the main body for holding the first circuit board, and a second holder provided at the main body or the first holder for holding the second circuit board in spaced relation to the first circuit board in the first direction. For example, the body may include a main body and first and second holders provided at the main body in spaced relation to each other in the first direction, and the first and second holders may hold the first and second circuit boards, respectively. In this case, each of the first and second holders may include one or more plates or pedestals for holding the first circuit board and the second circuit board, respectively. Further, the first and second holders may be connection portions of a switch and/or a terminal. Specifically, the connection portions of a switch and/or a terminal may pass through the first and second circuit boards to hold the first and second circuit boards in spaced relation to each other along the first direction.

The second holder 330a of the above embodiment includes the four pillars 321a on the first holder 320a. However, the second holder of the invention can be modified in any manner as long as it is provided at the main body or the first holder, the second holder being configured to hold the second circuit board in spaced relation to the first circuit board in the first direction. For example, the second holder may be modified in the above described manner.

The case 300b of the above embodiment is attached to the main body 310a of the body 300a. However, the case of the invention is not limited thereto. For example, the case may be integral with the body.

The push switch of the above embodiment includes the lens 700a, the light shield block 700b, the coil spring 800 for providing returning force, and the tactile feel generator 900. These components can be omitted. Further, if the first and second contacts include external connection portions, the terminals T1 to T8 can be omitted. The terminals T1 to T8 may be replaced with external connection units of other types, such as cables, pins, and FPCs.

It should be appreciated that the embodiments and modifications are described above by way of examples only. The materials, shapes, dimensions, numbers, arrangements, and other configurations of the constituents of the push switch may be modified in any manner if they can perform similar functions. The push switch of the above embodiment is a parking switch. However, the push switch is applicable to push switches of other types.

### REFERENCE SIGNS LIST

100: keytop
200: slider
300a: body
310a: main body
320a: first holder
330a: second holder
331a: pillar
340a: third holder
300b: case
310b: case body
320b: connection portion
400a: first circuit board
410a: protrusion
420a: guide recess
400b: second circuit board
410b: fitting hole
420b: fitting recess
500a: electronic component
500b: electronic component
600a: first circuit
600b: second circuit
700a: lens
700b: light shield block
800: coil spring
900: tactile feel generator
S1: switch
S11: first fixed contact
S12: second fixed contact
S13: movable contact
S2: switch
S21: first fixed contact
S22: second fixed contact
S23: movable contact
T1 to T8: terminal
Z: first direction
X: second direction
Y: third direction

1. A push switch comprising:
a keytop movable in a first direction;
a switch configured to be turned on or off in response to movement of the keytop;
first and second circuit boards electrically connected to the switch,
an electronic component mounted on the second circuit board;
a first circuit provided on the first circuit board and configured to protect the switch;
a second circuit provided on the second circuit board and configured to actuate the electronic component in response to a turn-on or turn-off of the switch; and
a body, the body including:
a main body;
a first holder provided at the main body, the first holder being configured to hold the first circuit board; and
a second holder provided at the main body or the first holder, the second holder being configured to hold the second circuit board in spaced relation to the first circuit board in the first direction.

2. The push switch according to claim 1, wherein the switch includes:
first and second fixed contacts, each comprising a metal plate passing through the first and second circuit boards; and
a movable contact, the movable contact at an initial position not being in contact with at least one of the first fixed and second fixed contacts, the movable contact being movable from the initial position in response to the movement of the keytop to be in contact with the first and second fixed contacts.

3. The push switch according to claim 1, wherein the switch includes:
first and second fixed contacts, each comprising a metal plate passing through the first and second circuit boards; and
a movable contact, the movable contact at an initial position being in contact with the first fixed and second fixed contacts, the movable contact being movable from the initial position in response to the movement of the keytop so as to be brought out of contact with at least one of the first and second fixed contacts.

4. The push switch according to claim 2, wherein
the body partially holds the first and second fixed contacts, and
the first and second fixed contacts each include a connection portion, the connecting portion being disposed outside the body and passing through the first and second circuit boards.

5. The push switch according to claim 3, wherein
the body partially holds the first and second fixed contacts, and
the first and second fixed contacts each include a connection portion, the connecting portion being disposed outside the body and passing through the first and second circuit boards.

6. The push switch according to claim 1, wherein
the second holder includes a plurality of pillars on the first holder, the pillars extending in the first direction,
the second circuit board is held on the pillars, and
the first circuit board is placed on the first holder so as to abut the pillars and be fixed in position by the pillars.

7. The push switch according to claim 2, wherein
the second holder includes a plurality of pillars on the first holder, the pillars extending in the first direction,
the second circuit board is held on the pillars, and
the first circuit board is placed on the first holder so as to abut the pillars and be fixed in position by the pillars.

8. The push switch according to claim 3, wherein
the second holder includes a plurality of pillars on the first holder, the pillars extending in the first direction,
the second circuit board is held on the pillars, and
the first circuit board is placed on the first holder so as to abut the pillars and be fixed in position by the pillars.

9. The push switch according to claim 4, wherein
the second holder includes a plurality of pillars on the first holder, the pillars extending in the first direction,
the second circuit board is held on the pillars, and
the first circuit board is placed on the first holder so as to abut the pillars and be fixed in position by the pillars.

10. The push switch according to claim 5, wherein
the second holder includes a plurality of pillars on the first holder, the pillars extending in the first direction,
the second circuit board is held on the pillars, and
the first circuit board is placed on the first holder so as to abut the pillars and be fixed in position by the pillars.

11. The push switch according to claim 6, wherein the first circuit board includes a guide recess configured to fittingly receive the pillars in a movable manner in the first direction.

12. The push switch according to claim 7, wherein the first circuit board includes a guide recess configured to fittingly receive the pillars in a movable manner in the first direction.

13. The push switch according to claim 8, wherein the first circuit board includes a guide recess configured to fittingly receive the pillars in a movable manner in the first direction.

14. The push switch according to claim 9, wherein the first circuit board includes a guide recess configured to fittingly receive the pillars in a movable manner in the first direction.

15. The push switch according to claim 10, wherein the first circuit board includes a guide recess configured to fittingly receive the pillars in a movable manner in the first direction.
